(19) United States
(12) Patent Application Publication
(10) Pub. No.: US 2010/0272528 A1
(43) Pub. Date: Oct. 28, 2010

(54) DRILLING MODULE FOR CREATING MULTIPLE DRILL HOLES IN A COMPONENT AND MOBILE DRILLING DEVICE UNIT FOR ARRANGEMENT ON A VEHICLE, IN PARTICULAR WITH THIS TYPE OF DRILLING MODULE

(75) Inventors: Peter BEE, Jenins (CH); Gerhard Greisl, Kaufering (DE)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/764,834

(22) Filed: Apr. 21, 2010

(30) Foreign Application Priority Data
Apr. 24, 2009 (DE) 10 2009 002 636.3

(51) Int. Cl. B23B 39/16; B23B 47/26

(52) U.S. Cl. 408/43; 408/46; 408/237

(57) ABSTRACT

A drilling module for creating multiple drill holes in a component is disclosed. The drilling module includes several drilling units and a basic frame having a displacement device for displacing the drilling units in a first direction. The displacement device is configured such that the drilling units can be arranged displaceably on the basic frame in a second direction differing from the first direction. A drilling device unit for arrangement on a vehicle is also disclosed.

This application claims the priority of German Patent Document No. 10 2009 002 636.3, filed Apr. 24, 2009, the disclosure of which is expressly incorporated by reference herein.

### BACKGROUND AND SUMMARY OF THE INVENTION

The invention relates to a drilling module for creating multiple drill holes in a component. In addition, the invention relates to a mobile drilling device unit for arrangement on a vehicle, in particular with this type of drilling module.

Traffic infrastructure includes constructions, such as, for example, streets, railway tracks, bridges, viaducts, tunnels and the like, on which additional elements, such, for example, overhead contact lines, cable conduits, sprinkler systems, railings or hand rails, must be arranged.

For example, in the case of concrete roads, cross pins are provided between the laterally adjoining traffic lanes as additional elements, which in operation prevent non-uniform settling of the traffic lanes and therefore height differences between the lanes of traffic. To this end, after creating the first traffic lane, several drill holes spaced apart from one another are created laterally, in which the cross pins are inserted prior to creating the second traffic lane.

In the case of renovations, for example, of bridges and viaduct decks, a layer of new concrete is frequently applied to the existing old concrete to increase the load bearing capacity of this component. In order to guarantee a monolithic bond between the old and new concrete, a plurality of connecting elements spaced apart from one another at specific distances is provided, which, before the new concrete is poured, are anchored in multiple drill holes created in advance in the old concrete.

A drilling module, which includes several drilling units and a basic frame with a displacement device for displacing the drilling units in a first direction along a longitudinal support, is known from GB 2 196 276 A for creating drill holes arranged in a line and at a specific distance from one another in a component.

The disadvantage of the known solution is that only hole patterns with drill holes arranged in a line can be created in a component with this drilling module.

A railing or guide rail that can be fixed to a component, like a bridge or a viaduct, has several fastening points spaced apart from one another in two directions, which are arranged at uniform distances from one another. Therefore, to fasten these elements to a component, multiple drill holes are created in the component, whose hole pattern and distances from one another correspond to the design and arrangement of the fastening points of the element being fixed. A precise design of the drill holes is required in order to guarantee simple assembly of the element being fixed to the component and to avoid unnecessary stress as well as any resulting damage to the element being fixed.

For this purpose, a mobile drilling device unit with a drilling module is known from U.S. Pat. No. 4,915,549, which has four column-mounted drilling units spaced apart from one another. Each drilling unit is movable relative to the component via a feed device. The columns of drilling units are provided in a basic frame, which includes a vertically aligned supporting frame, which is formed by horizontally and vertically aligned supporting elements with respective fastening openings spaced apart from one another to fix the drilling units to the basic frame. The basic frame is arranged on a movable scissor-type work platform. Two drilling units are respectively displaceable relative to one another, wherein to do so a plurality of fastening bolts has to be loosened and retightened.

The disadvantage of the known solution is that the drilling units can be displaced with respect to one another only in a predetermined grid, which is determined by the distance of the fastening openings in the horizontally and vertically aligned supporting elements respectively. In order to modify the distance of the drilling units from one another in both a first direction as well as in a second direction differing from the first direction, for example, first the stacked drilling units must be displaced relative to one another and then the vertical supporting elements bearing the previously displaced drilling units must be displaced relative to one another in the second direction, whereby the effort to align the drilling units with one another is time-consuming as well as costly in terms of labor.

Another disadvantage of the known solution is that this mobile drilling device unit can only be arranged on a vehicle, such as, for example, a truck, railway car or a ship, with specially designed fastening devices.

The object of the invention is to create a drilling module, in which the distance of the drilling units can be adjusted simply and flexibly. Furthermore, the object of the invention is creating a mobile drilling device unit for arrangement on a vehicle, which is able to be arranged in a simple manner on the vehicle.

According to the invention, the displacement device is configured such that at least one drilling unit can be arranged displaceably on the basic frame in a second direction differing from the first direction.

Because of the displaceabilty of at least one of the drilling units in both directions, different hole patterns can be created in a component in a simple manner with a type of drilling module. In this connection, displaceable means that the movement is carried out continuously and therefore the positioning of the at least one drilling unit between the specified end points is not bound by a predetermined grid. After the drilling unit(s) are aligned in the desired position relative to one another, the drilling units are fixed on the basic frame via a tensioning device, such as, for example, a tensioning screw.

The displacement device preferably makes a displacement of at least one drilling unit possible both in the first direction as well as in the second direction, whereby the displacement device can be configured as one piece. The displacement device advantageously comprises a guiding slide as a displacement element, along which the at least one drilling unit can be displaced in a guided manner. For simple displaceability of the at least one drilling unit, the guiding slide runs advantageously in a straight manner. Alternatively, the guiding slide also has a curved or discontinuous progression.

The displacement in both directions is preferably carried out in an overlapping manner, wherein the at least one drilling unit is advantageously displaceable in the first and the second directions simultaneously. If the displacement device includes a guiding slide as a displacement element, along which the at least one drilling unit can be displaced in a guided manner, this slide advantageously runs in the plane spanning from the two directions and at an angle from the first direction as well as from the second direction.

Alternatively, the guiding slide runs first in one direction and then in the other direction, wherein the branch-off from the one direction to the other direction may also be provided between the end points of the guiding slide running in the one direction.

The displacement device preferably comprises a first displacement element for displacing at least one drilling unit in the first direction and a second displacement element for displacing the at least one drilling unit in the second direction, whereby the displacement device may be configured to be multi-part. In this case, each of the displacement elements may be arranged displaceably on the basic frame only in one direction or at least one of the displacement elements also in both directions.

The drilling module advantageously has contact supports running parallel to the drilling axis of the drilling units, which, after alignment of the drilling module on the substrate, rest against the drill module and are provided especially advantageously in each of the corners of the basic frame. In addition, the contact supports are configured advantageously to be multi-part as well as telescoping, wherein at least one part of the multi-part contact support is advantageously spring loaded in the direction of the free end of the contact support. As a result, the contact supports rest completely on the substrate even in the case of curved surfaces, such as, for example, the arches of tunnels.

Furthermore, the drilling module advantageously has a centering rod running parallel to the drilling axis of the drilling units, which is directed at a marking point for the correct alignment of the drilling module on the substrate thereby ensuring precise creation of the drill holes in the component. The centering rod is provided advantageously in the center point of the hole pattern being created, between the drilling units. The centering rod is configured especially advantageously to be multi-part as well as telescoping, wherein at least one part of the multi-part centering rod is spring loaded in the direction of the free end of the centering rod. As a result, the centering rod adjusts in length when the drilling module is applied to the substrate.

According to the invention, a mobile drilling device unit for arrangement on a vehicle, which has at least one fastening device for securing at least one standardized platform, and for creating multiple drill holes in a component, has a drilling device, which has a lifting mechanism and a drilling module, wherein the drilling device is arranged on the standardized platform and can be secured thereto with the fastening device of the vehicle.

In the international movement of goods, containers have gained acceptance as a means of transport; these containers have a standardized platform and therefore can be secured on different types of vehicles, such as, for example, trucks, railway cars or ships, with the vehicle's fastening device.

Because the drilling device is arranged on the standardized platform, the fastening device that is already provided on the vehicle can be used to secure it. As a result, it is possible to use the drilling device unit flexibly on roadways, railways as well as waterways. The drilling device is arranged advantageously on the standardized platform in a detachable manner.

The lifting mechanism is, for example, a crane boom, a hoisting platform or the like, and furthermore advantageously has a connecting head for the drilling module, which makes rotations in three different directions possible. In addition, an operator platform with a control unit for controlling the drilling device and/or the drilling device unit is provided advantageously on the lifting mechanism. The lifting mechanism, in particular in the form of a crane boom, also makes work on the secondary track possible, for example, in the case of a dual track railway tunnel, thereby ensuring efficient and flexible work with the drilling device unit.

The standardized platform is a container frame of a 10-foot container, which can be secured in a simple manner on conventional container trucks, container train cars or container ships. In addition to standard gauge rail cars, these standardized platforms can also be secured on narrow gauge rail cars.

The drilling device unit preferably comprises a supply unit and/or disposal unit, which are arranged on a standardized platform, wherein the supply unit and/or disposal unit are arranged on the same or on a separate standardized platform. If the standardized platform is a container frame of a 10-foot container and if the supply unit and/or disposal unit are arranged on a standardized platform that is separate from the standardized platform of the drilling device unit, then both of these standardized platforms can be arranged in succession on a conventional container truck, container rail car or container ship. The supply unit and the disposal unit are arranged advantageously on a common standardized platform. Alternatively, the supply unit and the disposal unit may be provided on separate standardized platforms, thereby providing even greater flexible modularity for the drilling device unit. In addition, the supply unit and the disposal unit can be arranged on separate platforms, which for their part can be arranged as needed on a standardized platform.

The supply unit includes, for example, a generator for generating power, a compressor for generating compressed air, an electrical distributor for distributing the electrical energy and/or a fresh water tank with a pump for providing rinse water to support the drilling process, and cleaning water. In addition, the supply unit advantageously includes illumination means that can be used to adequately illuminate the work area.

The disposal unit includes, for example, a suction device for suctioning off drill dust and drill debris, a collection container. e.g., for the resulting drill dust and drill debris, a process water tank to collect the incident process water and/or a recycling device, which can be used to process, for example, the incident process water on site for another use.

The drilling device unit preferably comprises a drive unit for displacing the drilling device secured on the vehicle, whereby the vehicle, in particular a rail car, can be displaced in an autarkic manner. The drive unit advantageously has a motor, which the supply unit also supplies with the required energy for operation. A separate drive unit is advantageous, especially in the case of a rail car as the vehicle for the mobile drilling device unit, because this makes it possible to dispense with a locomotive controlled by a specialist for displacing the rail car from workplace to workplace. A separate lifting mechanism is provided advantageously for the drive unit, whereby the drive unit can be lowered as needed to the ground or can be loaded on the vehicle.

The drilling device preferably has a support device, which after reaching the desired work location, makes it possible to support the drilling device unit on the substrate and thereby prevent the vehicle with the drilling device unit secured thereto from tipping over during operation.

The drilling device unit preferably comprises a measuring device having a first beam source for generating a first measuring beam and having a second beam source for generating a second measuring beam, wherein the point of intersection formed by the first measuring beam and the second measuring beam forms a marking point for aligning the drilling module. The beam sources are formed advantageously as line lasers and allow an exact alignment of the drilling module with the substrate for a precision creation of the drill holes.

At least one of the beam sources is preferably arranged relative to the standardized platform displaceably on the standardized platform and can be aligned on the standardized platform in accordance with the to-be-displayed marking point. The second beam source may also be arranged on the standardized platform or is provided spaced apart from it. If the second beam source is arranged spaced apart from the standardized platform, this is advantageously provided on a separate unit, which for its part is movable or displaceable. In the case of a railway track system, the second beam source is arranged detachably, for example, on a car that is coordinated with the track gauge of the rails.

The invention is explained in greater detail in the following on the basis of exemplary embodiments.

### BRIEF DESCRIPTION OF THE DRAWINGS

FIG. 1 is a perspective view of a drilling module;

FIG. 2 is a top view of a drilling module with an alternative displacement device;

FIG. 3 is a perspective view of a first exemplary embodiment of a mobile drilling device unit;

FIG. 4 is a detailed section through the guidance device for the first beam source;

FIG. 5 is a perspective view of a second exemplary embodiment of a mobile drilling device unit; and

FIG. 6 is a perspective view of a third exemplary embodiment of a mobile drilling device unit.

### DETAILED DESCRIPTION OF THE DRAWINGS

As a rule, the same parts are provided with the same reference numbers in the figures.

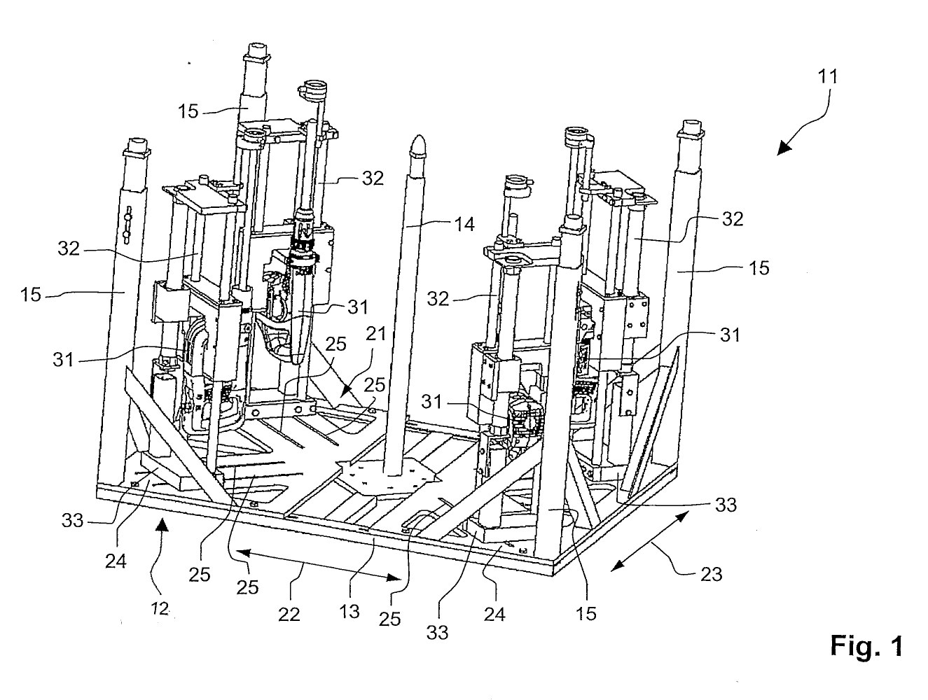

The drilling module 11 depicted in FIG. 1 for creating multiple drill holes in a component includes four drilling units 31, in this case diamond drill units with a rotationally driven annular core bit as a tool, and a basic frame 12 having a displacement device 21 for displacing the drilling units 31 in a first direction 22 and in a second direction 23 differing from the first direction 22. The drilling units 31 are each mounted on a column 32 and can be moved relative to the component, for example, via an electric or pneumatic feed device. The drilling units 31 are each detachably fixed on a slide, which can be moved along the column 32 by the feed device for feeding towards the component and for moving the drilling units 31 back into an initial position away from the component.

The basic frame 12 has a base frame 13, which extends in the first direction 22 and in the second direction 23 running perpendicular to the first direction 22. Provided in the center point of the base frame 13 is a centering pin 14 projecting perpendicularly to the plane spanning from the base frame 13, which centering pin is configured to be multi-part and telescoping. The part of the centering pin 14 provided on the free end is spring loaded in the direction of the free end via an internal spring element (not shown here).

The displacement device 21 includes a two-part base plate 24 as a displacement element, the parts of which are arranged displaceably relative to one another in the first direction 22 on the base frame 13. Provided for each column 32 in the parts of the base plate 24 are two parallel guiding slides 25 running straight that are also at an angle to the first direction 22 and to the second direction 23, with which the displacement device 21 makes a displacement of the drilling units 31 possible in both the first direction 22 as well as in the second direction 23. Displacement is carried out as a result in an overlapping manner or simultaneously in both directions 22 and 23.

The columns 32 each have a foot plate 33, from which fastening bolts (not shown here) that penetrate the guiding slides 25 project, via which the corresponding drilling unit 31 can be fixed to the basic frame 12, e.g., in combination with clamping nuts of the columns 32.

A contact support 15 projecting perpendicularly from the plane spanning from the base frame 13, which contact support is configured to be multi-part as well as telescoping, is provided in each of the two outer corner points of the base plates 24. The part of the contact support 15 provided on the free end is spring loaded in the direction of the free end via an internal spring element (not shown in this case).

To create the desired hole pattern, the tensioning of the corresponding columns 32 is loosened, they are displaced with the drilling units 31 into the appropriate position and then secured again. The displacement of each column 32 is independent of any grid and limited in a first step only by the ends point of the guiding slides 25. In order to be able to still position the drilling units 31 over a larger area relative to one another, the fixations (not depicted here) of the parts of the base plate 24 are loosened and they are displaced relative to one another into the desired position as well as then again secured on the base frame 13.

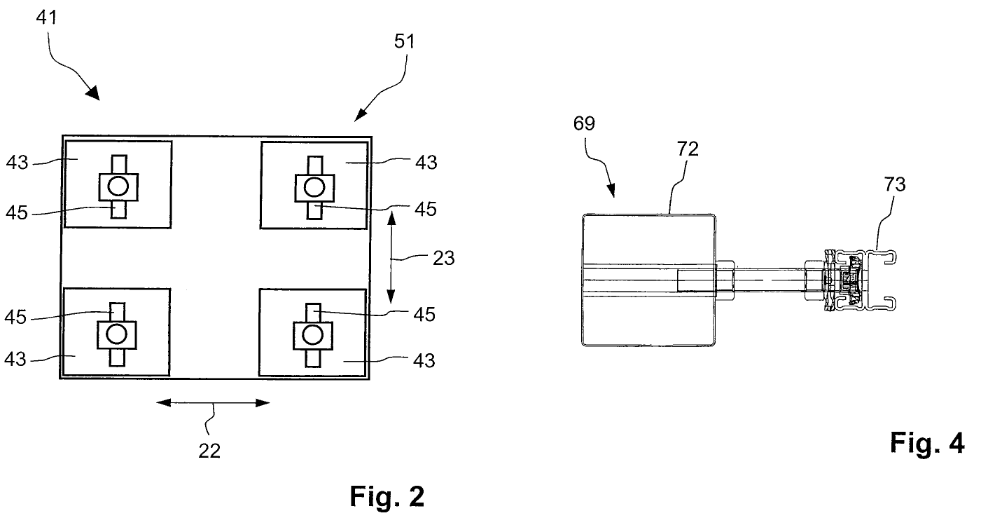

FIG. 2 shows a drilling module 41 with a four-part base plate 43, whose parts as a first displacement element of the displacement device 51 permit a displacement of a drilling unit in a first direction 22 and/or in a second direction. A straight guiding slide 45 running in the direction of the second direction 23 is provided in each part of the base plate 43, and they form a second displacement element of the displacement device 51 for displacing a drilling unit in the second direction 23. Alternatively, the guiding slide 45 can also be arranged running in the direction of the first direction 22. In addition, several crossing guiding slides running in several directions can also be provided on the parts of the multi-part base plate, thereby allowing a plurality of positioning possibilities of the drilling units relative to one another.

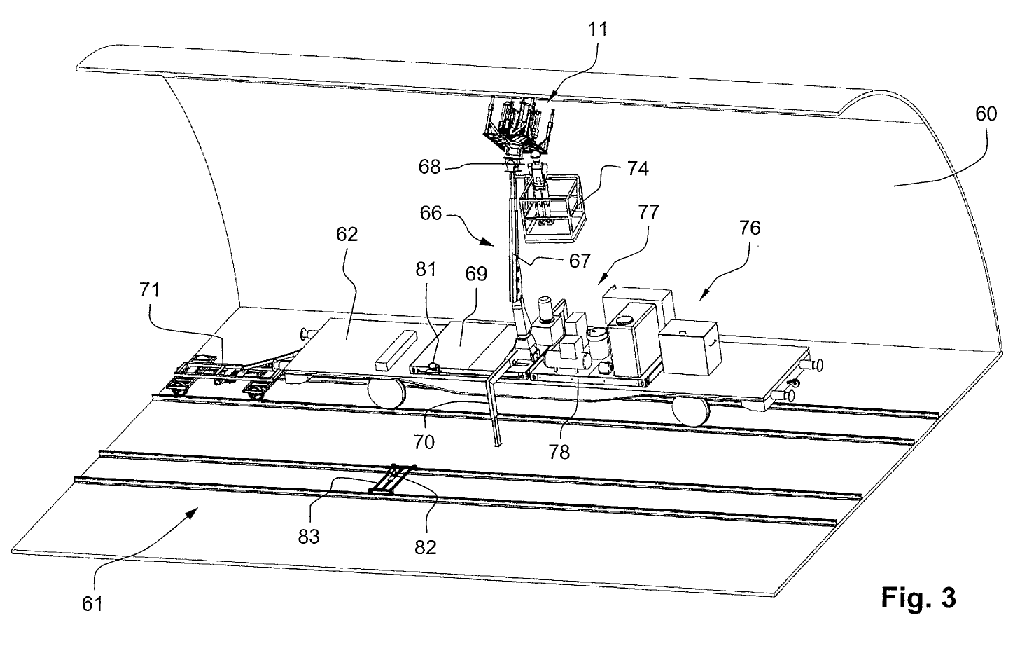

FIG. 3 depicts a mobile drilling device unit 61 for creating multiple drill holes in a tunnel wall as the component 60, which unit is arranged on a rail car as the vehicle 62. The drilling device unit 61 includes a drilling device 66, which has a crane boom as the lifting mechanism 67, on whose free end a drilling module 11 is provided via a head 68 that can be rotated in three dimensions. In addition, an operating platform 74 with a control console is provided on the lifting mechanism 67, via which a user can control the drilling device 66 as well as the drilling device unit 61.

The drilling device 66 is arranged on a standardized platform 69 and can be fixed thereto with a fastening device of the vehicle 62 that is coordinated with this standardized platform 69. The standardized platform 69 is a container frame of a 10-foot container. In addition, the drilling device 66 features a support device 70, which prevents the vehicle 62 from tipping over when raising, lowering and moving the lifting mechanism 67.

Furthermore, the drilling device unit 61 includes a drive unit 71 that can be lowered by the vehicle 62, which makes displacing the vehicle 62 with the drilling device 66 secured thereon possible without the use of, for example, a locomotive.

The drilling device unit 61 also includes a supply unit 76 for supplying the drilling device 66 with energy as well as operating resources and has a disposal unit 77 for collecting the incident drill dust or drill debris and process water. The supply unit 76 and the disposal unit 77 are arranged on a separate standardized platform 78. The standardized platform 78 is also advantageously a container frame of a 10-foot container, with which this standardized platform 78 and the standardized platform 69 of the drilling device 66 can be secured in succession on a conventional vehicle 62 for the transport of containers using the fastening device that is already provided thereon.

In addition, the drilling device unit 61 includes a measuring device having two line lasers as the first beam source 81 and the second beam source 82. The point of intersection of the measuring beams of these beam sources 81 and 82 forms a marking point on the tunnel wall for aligning the drilling modules 11.

The first beam source 81 is arranged relative to the standardized platform 69 displaceably on the standardized platform 69. As FIG. 4 shows, an assembly rail 73 running parallel to a frame profile 72 of the standardized platform 69 and spaced apart therefrom is provided for this purpose, on which the line laser as the first beam source 81 can be fixed at will along the assembly rail 73 with correspondingly configured connecting parts.

The second line laser is provided as the second beam source 82 on a trolley 83, which has a track gauge coordinated with the rails. The track gauge of the trolley 83 or of the wagon can be adjusted advantageously to narrow gauge and standard gauge.

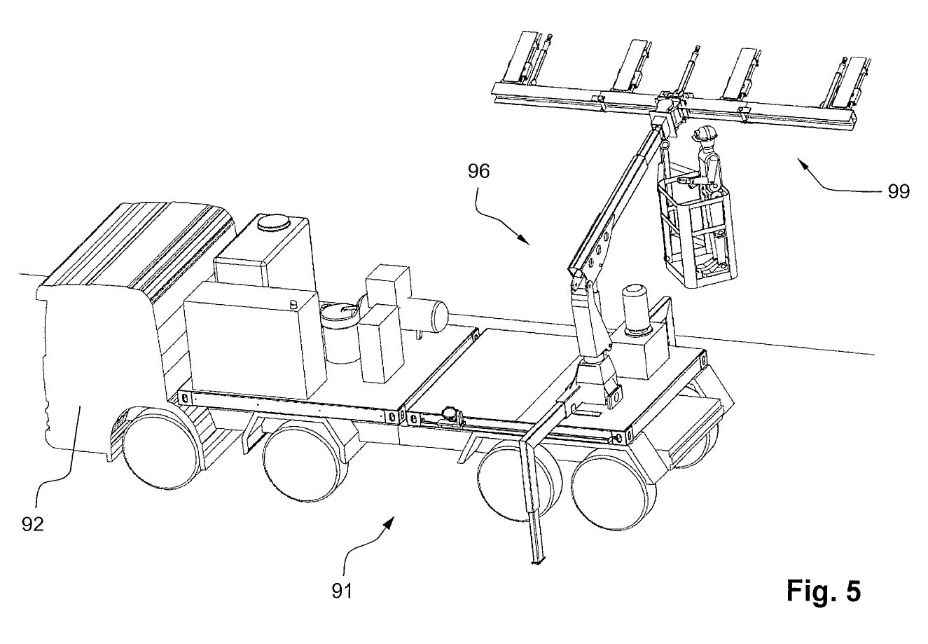

The mobile drilling device unit 91 depicted in FIG. 5 is essentially configured like the previously described drilling device unit 61, however, it is secured on a truck configured for container transport as the vehicle 92. Another difference is that the drilling device 96 of the drilling device unit 91 features a drilling module 99, with which multiple drill holes lying in a line can be created in a tunnel wall as the component 90.

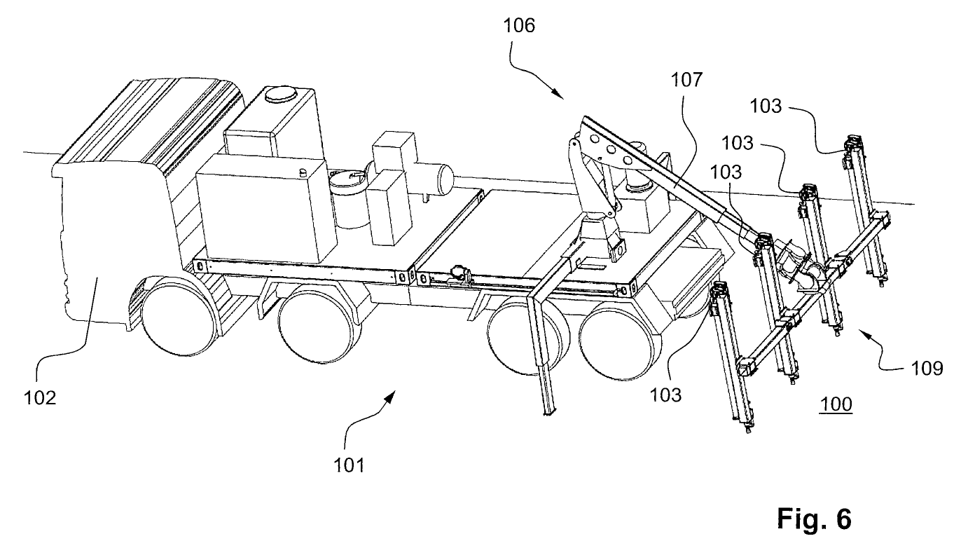

The mobile drilling device unit 101 depicted in FIG. 6 is essentially configured like the previously described drilling device unit 91 and is also secured on a truck as the vehicle 102. In contrast to the drilling device unit 91, the drilling module 109 shown here is configured for creating multiple drill holes lying in a line in the ground as the component 100. The drilling module 109 includes drill hammers as the drilling units 103. In the case of this drilling device 106, control is carried from the ground or directly from the vehicle 102, whereby a separate operator platform does not have to be provided on the lifting mechanism 107.

The mobile drilling device units 61, 91 and 101 are characterized by their modularity. Foundation parts of the drilling device units 61, 91 and 101 form the standardized platforms 69 and 78 with the elements arranged thereon. Depending upon the use, the user arranges the appropriate drilling module 11, 96 or 106 on the lifting mechanism 67 or 107 and secures the drilling device 66, 96 and 106 on the desired vehicle 62, 92, 102. Because the platforms 69 and 78 are advantageously standardized container frames, the drilling device units 61, 91 and 101 can be securely modularly and simply on different vehicles 62, 92 and 102 that are suitable for the transport of containers.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drilling module for creating multiple drill holes in a component, comprising:
a plurality of drilling units; and
a basic frame having a displacement device for displacing the plurality of drilling units in a first direction;
wherein the displacement device is configured such that at least one of the plurality of drilling units is arrangeable displaceably on the basic frame in a second direction differing from the first direction.

2. The drilling module according to claim 1, wherein the displacement device is configured to displace the plurality of drilling units in both the first direction and the second direction.

3. The drilling module according to claim 1, wherein the displacement device is configured to displace the at least one of the plurality of drilling units in both the first direction and the second direction in an overlapping manner.

4. The drilling module according to claim 1, wherein the displacement device includes a first displacement element for displacing the at least one of the plurality of drilling units in the first direction and a second displacement element for displacing the at least one of the plurality of drilling units in the second direction.

5. A mobile drilling device unit for arrangement on a vehicle, comprising:
a standardized platform;
a fastening device associated with the standardized platform; and
a drilling device which has a lifting mechanism and a drilling module, wherein the drilling device is arranged on the standardized platform and is securable to the standardized platform by the fastening device.

6. The mobile drilling device unit according to claim 5, wherein the drilling module comprises:
a plurality of drilling units; and
a basic frame having a displacement device for displacing the plurality of drilling units in a first direction;
wherein the displacement device is configured such that at least one of the plurality of drilling units is arrangeable displaceably on the basic frame in a second direction differing from the first direction

7. The mobile drilling, device unit according to claim 5, further comprising:
a supply unit and/or a disposal unit which are arranged on the standardized platform or on separate standardized platforms.

8. The mobile drilling device unit according to claim 5, further comprising a drive unit for displacing the drilling device.

9. The mobile drilling device unit according to claim 5, wherein the drilling device includes a support device.

10. The mobile drilling device unit according to claim 5, further comprising a measuring device having a first beam source for generating a first measuring beam and having a second beam source for generating a second measuring beam, wherein a point of intersection formed by the first measuring beam and the second measuring beam forms a marking point for aligning the drilling module.

11. The mobile drilling device unit according to claim 10, wherein at least one of the first and second beam sources is arranged relative to the standardized platform displaceably on the standardized platform.
